(19) United States
(12) Patent Application Publication
(10) Pub. No.: US 2012/0178170 A1
(43) Pub. Date: Jul. 12, 2012

(54) SAMPLE CONTAINER INTELLIGENT RACK AND LOADING METHOD

(76) Inventor: Peter Van Praet, Haasrode (BE)

(21) Appl. No.: 13/383,998

(22) PCT Filed: Jul. 16, 2010
(86) PCT No.: PCT/US2010/001998

§ 371 Date: Mar. 22, 2012

(30) Foreign Application Priority Data
Jul. 16, 2009 (BE) 2009/0435

(51) Int. Cl. G01N 35/02; B01L 9/00

(52) U.S. Cl. 436/47; 422/65; 422/561

(57) ABSTRACT

An intelligent rack automatically detects the position of a specimen tube within a multiple specimen tube containing rack such as that utilized within automatic specimen processing apparatuses. The rack has a plurality of positions with a moving element located adjacent each position. The moving element, such as a spring, is positioned so that it moves when a specimen tube is placed within an adjacent position. A magnet or other sensor on the moving element interacts with a detector to sense when a particular position has received a specimen tube. A computer controlling the apparatus receives specimen information for each specimen tube and has an identifier for the specimen tube, such as a bar code, scanned into the computer before placement of the specimen tube into a rack position. Removal of the specimen tube from a position on the rack causes correlating removal of specimen tube position information from the computer.

### CROSS-REFERENCE TO RELATED APPLICATIONS

This application claims benefit of the earlier filing dates associated with International Application No. PCT/US2010/001998 filed on Jul. 16, 2010, which designates the United States and other countries; and BE 2009/0435 filed on Jul. 16, 2009 which was claimed for priority in the above-identified international application.

### FIELD OF THE INVENTION

The following invention relates to automatic sample processing equipment, such as that utilized in medical diagnostic and medical laboratory settings, and particularly which utilize automated robotic equipment for processing of specimens, typically which specimens reside in specimen tubes during such processing. More particularly, this invention relates to racks for such automatic sample processing apparatuses for holding the specimen tubes relative to other portions of the apparatus, and which racks can reliably keep track of the position of specimen tubes placed within such racks.

### BACKGROUND OF THE INVENTION

Medical diagnostic and testing laboratories, as well as other facilities rely heavily upon automated apparatuses to efficiently and reliably process a large number of specimens. Such automation allows particular processes to be conducted in a controlled manner, such as for diagnosing the presence of particular conditions within specimens. These processes can be tedious and time consuming to conduct by hand and if conducted by hand introduce the possibility for human error.

Such automatic apparatuses typically support a plurality of test tubes, also called specimen tubes, with each tube containing a specimen therein. These test tubes are held within a rack which supports multiple test tubes therein in a substantially vertical orientation. A robotic conveyance manipulates either the test tubes, reactant dispensing equipment, or both, as well as sensory equipment, to implement a variety of different processes on the specimen within the test tube so that a particular laboratory test or other process can be effectively conducted. Through such automation, such tests or other processes can be precisely controlled and reliably repeated.

One problem with utilization of such automatic specimen processing apparatuses is both the tedious entry of data before such automated processes can occur, and the potential for error associated with such initial data entry. In particular, it is important that the automated apparatus know which position within the rack each specimen is initially placed. If this position is incorrectly initially inputted, or if the specimen tube is moved to a new position on the rack after such position information has been inputted, the potential for mixing up specimens or other error exists.

A continuous ongoing desire exists in the field of automated specimen processing to prevent switching of specimens, for instance patient related specimens, so that erroneous identification of patients or erroneous swapping of test results can be eliminated. Various different methods have been established in the prior art to accurately provide patient or other specimen identification as well as specimen tube location information relative to the rack. Most commonly, a specimen is initially placed within a tube which is somehow coded, such as with a bar scanner. This bar code can be associated with a data file on a computer with the information relating to the specimen. The user then scans the bar code on the specimen tube. Next, the user places the specimen tube into a position on the rack.

In various prior art embodiments, the specimen tube positioning step can occur in different ways, such as by sequentially loading specimen tubes onto the rack, or by manual data entry of position information on the rack. For maximum efficiency in operation of the automatic specimen processing apparatus, the rack is often filled with specimen tubes, which could be an array of 8×8 positions on the rack (or more) such that a large number of specimen tubes are provided on the rack. Mis-positioning of specimen tubes through human error can easily occur with such prior art rack loading arrangements. Even after the rack has been loaded, if the specimen tube needs to be removed and replaced for any reason, the potential further exists for improperly replacing the specimen tube at a different position than where it was located previously, while the apparatus is expecting the specimen tube to be placed in the same location, so that error is introduced. Accordingly, such prior art specimen processing apparatuses are less than desirable.

In other known prior art methods, the rack is configured such as with a circular form so that positions on the rack follow a single path and the potential for improperly positioning specimen tubes is reduced. However, such carousel type circular racks do not as efficiently utilize available space, thus decreasing the throughput duty cycle for the specimen processing apparatus. Furthermore, the potential still exists for switching of specimen tubes or misplacement of specimen tubes in the incorrect locations with such systems.

In still other prior art methods, linear subsections of the racks are sequentially loaded and scanned in a manner simplifying somewhat the position recording information associated with specimen tubes. However, the potential for specimen misplacement or switching still exists, as well as the difficulty in handling elongated subparts of an overall rack assembly. Overall, a need exists for a rack for an automatic specimen processing apparatus which is intelligent in that the rack can be rapidly loaded with specimen tubes and reliably know which specimen tube is located at which position within the rack for efficient and reliable utilization of the specimen processing apparatus.

### SUMMARY OF THE INVENTION

With this invention an intelligent rack is provided for use within an automatic sample processing apparatus, such as a medical diagnostic sample analyzer. The sample processing apparatus generally includes process implementation equipment which can move relative to specimen tubes or other sample containers to insert reactants into the specimen tubes, and detection equipment which can sense characteristics of the specimen after interaction with a reactant or reactants.

The specimen tubes or other sample containers are held within the intelligent rack of the specimen processing apparatus. This rack includes multiple positions for specimen tubes. A computer is associated with the automatic specimen processing apparatus and a bar code scanner is also associated with the computer and/or the apparatus. Specimen data, such as patient identification data, is maintained within a database on the computer. One component of such a data set can include a bar code number corresponding with a bar code symbol placed upon the specimen tube associated with the specimen information within the data set. By utilizing a bar code scanner, a specimen associated with the data can be placed within a specimen tube and then the specimen tube brought close to the scanner and the scanner can automatically associate the bar code number with the data set for that specimen.

Uniquely with this invention, the rack is intelligent in that it automatically recognizes which position within the rack has been loaded with which specimen. In particular, the rack includes multiple positions with a presence sensor located adjacent each position within the rack. When a specimen tube is placed within a position in the rack, following scanning of the specimen with the bar code scanner, the presence sensor associated with each position detects the presence of the specimen tube. This detection is converted into a signal and communicated to the computer so that coordinates or other position identification data for the position where the specimen tube is located, can be correlated with other data associated with the specimen.

In one form of the invention this presence sensor can be in the form of a moving element, such as an elongate pivoting element which intersects the adjacent position in the rack somewhat and is displaced when the specimen tube is placed within the position associated with the moving element of the presence sensor. This moving element could for instance be a spring of elongate form at least partially extending into the space of this position. To detect movement of the moving tip, in one form of the invention a magnet is placed at a tip of the spring or other moving element. A magnetic field sensor, such as a Hall Effect sensor is located near the tip of the moving element to detect changes in intensity of magnetic field associated with movement of the tip of the moving element which occurs when a specimen tube is placed within the adjacent position within the specimen tube supporting rack.

According to this preferred embodiment, the procedure for loading a specimen into the rack of the automatic specimen processing apparatus is as follows:

On the computer, the software is started that is responsible for the entry of the patient data or other specimen data. Then an operator takes the first specimen tube that has been loaded with the first specimen and places it adjacent the bar code scanner. The bar code scanner reads the information that is on the tube and transmits it to the computer where this information is stored in a manner associated with other data associated with the specimen in the specimen tube.

The operator then places the tube into a position on the rack. The particular position where the specimen tube is placed is of no consequence. Wherever the specimen tube is placed, the intelligent rack detects the position that has been selected and correlates that position with the data set for the specimen. An appropriate process can then be implemented by the automatic specimen processing apparatus acting on the specimen tube at the particular position so associated with the data set. The intelligent rack detects the exact place where the tube was placed and sends this information to the computer for association with the data set associated with the specimen. This connection is maintained so long as the intelligent rack continues to detect the presence of the specimen tube at this position

If the specimen tube is afterward taken out of the rack, and this position in the rack is made free the bar code information connected to the space is deleted. Stated alternatively, position information in the data set associated with each specimen is eliminated from the data set whenever the specimen tube is removed. Even if one immediately replaces a specimen tube after removal therefrom, position information will not be restored to the data set in a most preferred embodiment of this invention, to prevent the possibility of operator error in removing and replacing a specimen tube in an incorrect position. Rather, the operator would be required to again scan the specimen tube with the bar scanner and repeat the step of placing the specimen tube anywhere within the intelligent rack, so that a new position within the intelligent rack can be correlated with the other data associated with that specimen. Only specimen tubes that remain unremoved retain their specific coordinates within the intelligent rack or other rack position information along with specimen information on the computer data set. The software running on the computer refuses to assign positions to specimen tubes that have not been previously successfully read by the bar code scanner. Reliable specimen position information is thus always maintained.

### OBJECTS OF THE INVENTION

Accordingly, a primary object of the present invention is to provide a rack for an automatic specimen processing apparatus which can support specimen tubes therein and which reliably correlates a position within the rack with other specimen data.

Another object of the present invention is to provide an automatic specimen processing apparatus which utilizes an intelligent rack to preclude swapping of specimens or otherwise mis-correlating specimen information with rack position information.

Another object of the present invention is to provide an automatic specimen processing apparatus which can process multiple specimen tubes simultaneously in an efficient high duty cycle fashion with minimized risk of mis-correlating specimen data with processes executed by the specimen processing apparatus.

Another object of the present invention is to provide medical specimen diagnostic equipment which reliably correlates particular specimens with particular patient data throughout the specimen processing operation.

Another object of the present invention is to provide a method for accurately correlating specimen position with other specimen data within an automated specimen processing apparatus.

Another object of the present invention is to provide an intelligent rack for an automated specimen processing apparatus which can detect where within a multiple position specimen tube supporting rack a particular specimen tube is being placed.

Another object of the present invention is to simplify the process of placing specimen tubes within an automatic specimen processing apparatus.

Another object of the present invention is to minimize the potential for errors in the operation of automatic specimen processing apparatus.

Other further objects of the present invention will become apparent from a careful reading of the included drawing figures, the claims and description of the invention.

### BRIEF DESCRIPTION OF THE DRAWINGS

FIG. 1 is a perspective view of the intelligent rack of this invention shown partially from above and with a printed circuit board thereof shown spaced an enhanced distance away from other portions of the intelligent rack to show the entire upper surface of the printed circuit board.

FIG. 2 is a bottom perspective view of that which is shown in FIG. 1 and showing details of an underside of the printed circuit board, as well as details of the intelligent rack, with the printed circuit board exploded away somewhat.

FIG. 3 is a perspective view of a spring defining a preferred form of moving element which acts as a form of specimen tube presence sensor within the intelligent rack of this invention.

FIG. 4 is a side elevation view of a portion of that which is shown in FIGS. 1 and 2, and illustrating how placement of a specimen tube within a position on the intelligent rack causes the presence sensor in the form of a moving element to move and cause a signal to be generated on a printed circuit board correlating with the presence of the specimen tube placed within the particular position on the rack. One such position is shown empty and another such position is shown filled with a specimen tube such that the presence sensors associated with each position can be seen in both a configuration associated with no specimen tube located within the associated position and correlating with the presence of a specimen tube located within the associated position.

FIG. 5 is a perspective view of an automatic specimen processing apparatus including a plurality of intelligent racks according to this invention placed therein for use according to this invention.

### DESCRIPTION OF THE PREFERRED EMBODIMENT

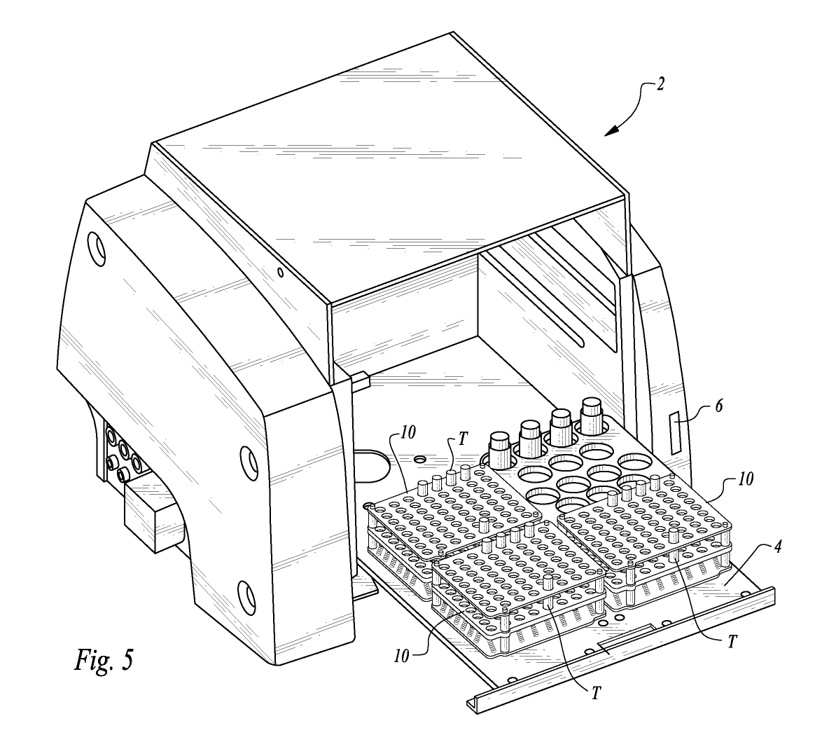

Referring to the drawings, wherein like reference numerals represent like parts throughout the various drawing figures for this exemplary embodiment, reference numeral 10 (FIG. 5) is directed to an intelligent rack for use in holding specimen tubes T within an automatic specimen processing apparatus, such as an analyzer 2, for automatically executing medical diagnostic processes. The intelligent rack 10 holds the specimen tubes T within the analyzer 2 while desired processes are executed by the analyzer 2. While specimen tubes T are specifically shown and described, the invention can be utilized with other sample containers held by other types of sample supports as well. The term sample can include both analytes and reagents, or other fluids, for purposes of defining the intelligent rack of this invention. The intelligent rack 10 keeps track of the specific position within the intelligent rack 10 where each specimen tube T or other sample container is located in an automated fashion, so that when multiple specimen tubes are located within the rack 10, problems associated with improperly mixing up the positions of the specimen tubes T within the rack 10 are avoided.

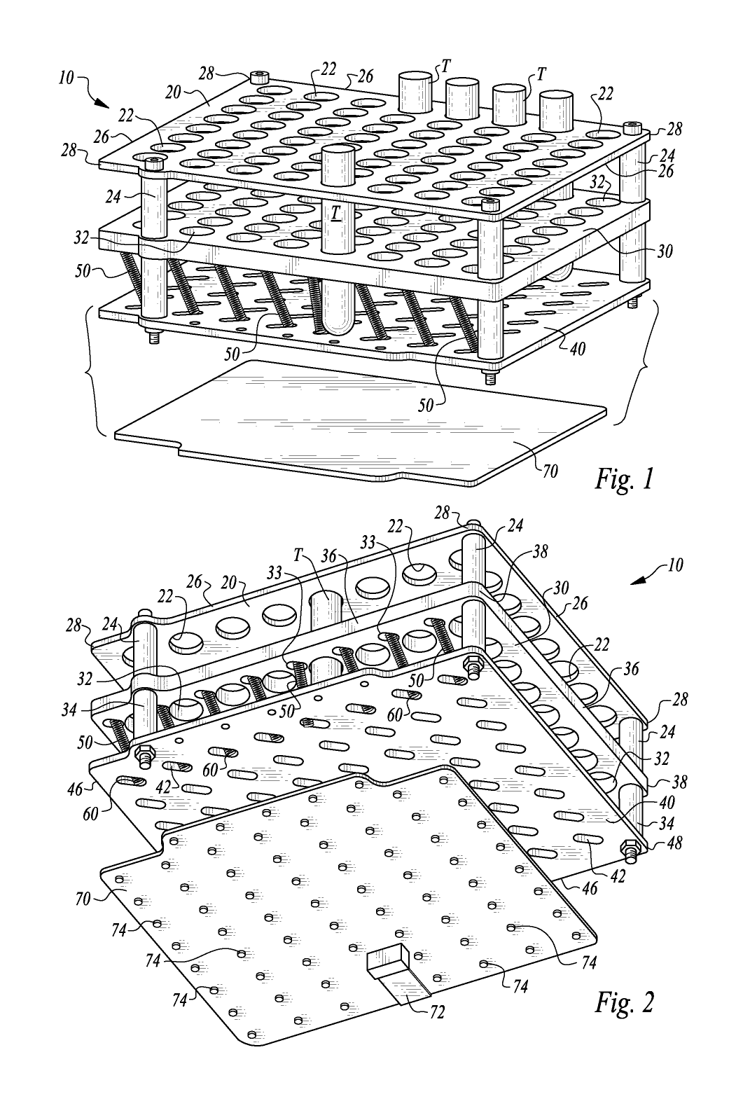

In essence, and with particular reference to FIGS. 1 and 2, basic details of the intelligent rack 10 are described according to a most preferred embodiment of this invention. The intelligent rack 10 includes a support for specimen tubes T or other sample containers which is most preferably in the form of a pair of parallel vertically spaced plates including a top plate 20 over a middle plate 30. Pairs of holes 22, 32 in the plates 20, 30 are oriented substantially vertically spaced from each other, so that specimen tubes T can pass through each of the pairs of holes 22, 32 in the top plate 20 and the middle plate 30 to hold the specimen tube T therein. An array of such holes provide a total number of positions for supporting specimen tubes T within the rack 10. A bottom plate 40 is located below the middle plate 30. This bottom plate 40 defines a floor for specimen tubes T located within the various different positions of the rack 10.

A spring 50 provides a preferred form of moving element associated with each of the positions within the intelligent rack 10. Each spring 50 extends at least partially into an associated position in the intelligent rack 10 so that when a specimen tube T is placed within the associated position, the spring adjacent the associated position is caused to move. A magnet 60 is coupled to a lower end of the spring and the spring has a lower end 54 which can pivot relative to an upper end 52 when a specimen tube T is placed within the associated position. The magnet 60 at the lower end 54 is thus caused to move when the specimen tube T is placed within the associated position. A printed circuit board 70 is located below the bottom plate 40. Hall Effect sensors 74 act as a preferred form of detector which detects the presence of the magnet 60 and proximity of the magnet 60 to determine whether the spring 50 has been moved and in turn whether a specimen tube T has been located within the associated position.

The printed circuit board 70 has an array of such detectors 74 with one detector 74 for each position in the intelligent rack 10. These detectors 74 are coupled to appropriate circuitry to generate signals correlated with positions on the intelligent rack 10 and to transmit a signal to an associated computer which communicates when a specimen tube T has been placed into a position on the intelligent rack 10 so that position information for the specimen tube T can be correlated with other data about the specimen tube T. Removal of the specimen tube T from the position is also detected by the detectors 74 on the printed circuit board 70 and a correlating signal is provided to decouple position data from other data associated with the specimen tube T, when such removal is detected.

More specifically, and with continuing reference primarily to FIGS. 1 and 2, specific details of the top plate 20 and middle plate 30 defining a preferred form of support for specimen tubes T within the intelligent rack 10 are described in the particular exemplary embodiment depicted herein. While the plates 20, 30 define a preferred form of support for the specimen tubes T, other forms of supports could alternatively be utilized. For instance, a cylindrical sleeve could replace the pairs of holes 22, 32 in the top plate 20 and middle plate 30. Also, conceivably a basic support for specimen tubes T could be provided with only a single plate, such as the top plate 20, or the middle plate 30, residing over the bottom plate 40. The support could also be configured with positions spaced vertically. If the specimen tube T were replaced with a specimen containing item having a differing configuration, other details of the intelligent rack 10 would be accordingly modified to accommodate such differences.

The top plate 20 is most preferably a planar rigid structure oriented within a substantially horizontal plane and defining an uppermost portion of the intelligent rack 10. An array of holes 22 pass entirely through the top plate 20. This array of holes 22 preferably is arranged with rows perpendicular to columns. In one embodiment this top plate 20 is substantially square in plan form with an equal number of holes 22 extending in each orthogonal direction, such as an 8×8 array of sixty-four holes 22.

Each of the holes 22 is preferably circular in form but could conceivably have other shapes. The holes 22 preferably have a diameter similar to a diameter of specimen tubes T, but slightly wider to allow for easy insertion and removal of specimen tubes into the holes 22. By keeping a sizing of the holes 22 similar to that of the specimen tubes T, precise positioning of the specimen tubes T can be maintained by the rack 10 to accommodate robotic equipment interacting with the specimen tubes T in a reliable and repeatable fashion.

The top plate 20 is preferably supported above the middle plate 30 through utilization of standoffs 24. These standoffs 24 are preferably provided at each corner 28 of the top plate 20 and extending substantially vertically between the middle plate 30 and top plate 20. Perimeter edges 26 of the top plate 20 define a plan form shape of the top plate 20 which, most preferably is substantially square.

In one embodiment the overall size of the top plate 20 and associated intelligent rack 10 is such that multiple intelligent racks 10 can fit within a single analyzer 2 (FIG. 5). For instance, in one embodiment a support tray 4 of the analyzer 2 can support three intelligent racks 10 thereon with a fourth position on the support tray 4 able to hold vials containing reactants for use in executing various processes to be conducted on specimens within the specimen tubes T inside the analyzer 2.

The analyzer 2 also preferably includes a bar scanner 6 or other ID detector therein and interconnection electronics so that signals from the intelligent rack 10 as well as from the bar code scanner 6 and from status information associated with the analyzer 2 can all be routed to a computer. Data acquisition software running on the computer maintains a record of the execution of the various processes and collects data associated with the processes being conducted by the analyzer 2 upon the specimens within the specimen tubes T. Details about each specimen or other sample can be automatically gathered, such as by use of a bar code scanner and/or computer file transfer, or can be entered manually.

The middle plate 30 is preferably similar in form to the top plate 20 with a substantially planar form and made of a substantially rigid material. Most preferably, the middle plate 30 is slightly thicker than the top plate 20 so that the top plate 20 provides primarily only alignment of the specimen tubes T placed within holes 22 of the top plate 20 and the holes 32 in the middle plate 30 provide primary support for the specimen tubes T. The holes 32 are similar in size to the holes 22 to allow for easy passage of specimen tubes T into and out of the holes 22, 32 defining positions within the rack 10. One hole 32 in the middle plate 30 is associated with each hole 22 in the top plate 20 with these pairs of holes 22, 32 defining separate positions within the intelligent rack 10.

The middle plate 30 further includes standoffs 34 extending downwardly from the middle plate 30 and aligned vertically beneath the standoffs 24 of the top plate 20. The standoffs 34 space the middle plate 30 above the bottom plate 40. Perimeter edges 36 of the middle plate 30 preferably are similar to the perimeter edges 26 of the top plate 20. Corners 38 define positions for the standoffs 34 and are preferably aligned with corners 28 of the top plate 20, so that a perimeter contour of the top plate 20 is similar to a perimeter contour of the middle plate 30.

The bottom plate 40 in this preferred embodiment is a substantially planar structure, preferably formed of rigid materials. The bottom plate 40 is coupled to the middle plate 30 at corners 48 thereof through the standoffs 34. A perimeter edge 46 of the bottom plate 40 is preferably similar to perimeter edges 36, 26 of the middle plate 30 and top plate 20.

Uniquely, the bottom plate 40 does not include holes, such as the holes 22, 32 therein. Thus, when specimen tubes T are passed down into a position within the intelligent rack 10, and passing through holes 22, 32 in the top plate 20 and middle plate 30 which are aligned together, the specimen tube T will stop when abutting an upper surface of the bottom plate 40. The bottom plate 40 thus defines a lowermost portion of each position within the intelligent rack 10.

The bottom plate 40 preferably includes slots 42 therein with a slot 42 partially intersecting each position of said intelligent rack 10, and partially slightly offset laterally from such positions. These slots 42 have a first end which is near a center vertical line of each position within the intelligent rack 10, and a second end spaced laterally from each position of the intelligent rack 10. The slots 42 act as guides for travel of a moving element, such as the spring 50, allowing the moving element to move within the slot 42 between a first location partially blocking the position within the intelligent rack 10 and a second location moved out of the specimen tube T position within the intelligent rack 10. The slots 42 preferably have a width similar to but slightly greater than a width of the spring 50 or other moving element, such that the slots 42 keep the spring 50 or other moving element from moving in any manner other than between ends of the slots 42 when the spring 50 or other moving element is impacted by placement of a specimen tube T into an adjacent position within the intelligent rack 10.

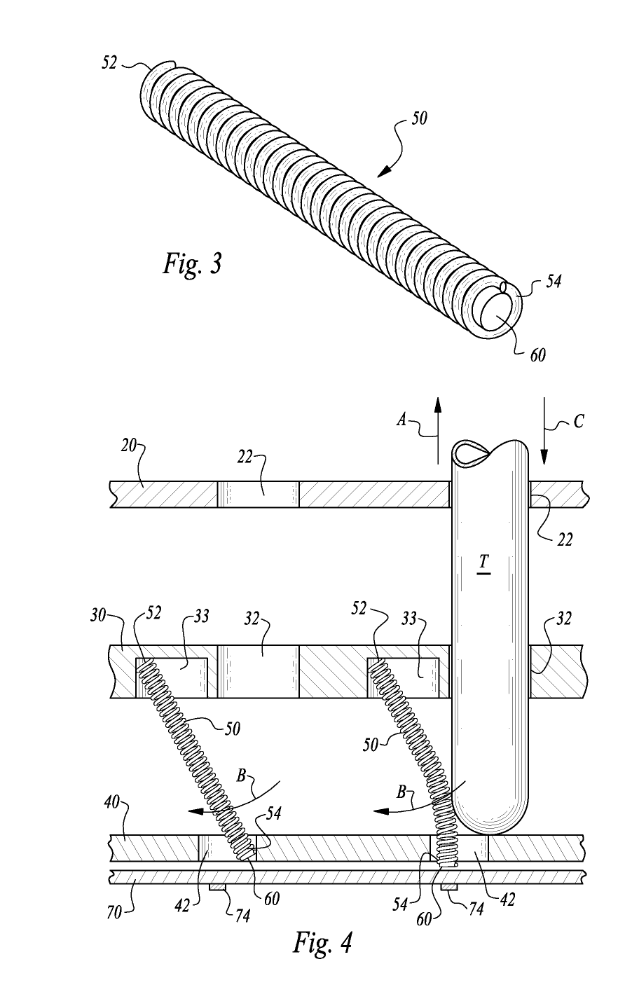

With continuing reference to FIGS. 1-4, details of spring 50 are described, as a preferred form of moving element. The spring 50 defines one effective configuration for the moving element which acts as a preferred form of presence sensor to sense the presence of a specimen tube T within a position adjacent to the spring 50 or other moving element.

The presence sensor could sense sample container presence without a moving element, as an alternative. For instance, RFID (radio frequency identification) tags and antennas on the sample containers and adjacent rack positions could detect sample container presence, or an array of sensors (e.g. electric, magnetic, acoustical, etc.) could use triangulation to identify the locating of samples on the rack and which positions are occupied. In this configuration utilizing the spring 50, the spring 50 is of an elongate form extending between an upper end 52 and a lower end 54. An upper end 52 is captured to the middle plate 50, such as within a cavity 33 formed in a lower surface of the middle plate 30. This upper end 52 of the spring 50 thus acts as a pivot for movement of the spring 50 or other moving element.

The lower end 54 opposite the pivot end 52 acts as a tip of the moving element which moves relative to the pivot upper end 52. The spring 50 is preferably a relatively low strength spring so that only a low amount of force is required to cause the spring 50 to deflect and to cause the lower end 54 of the spring 50 to move within the slot 52 from the first end of the slot 52 more aligned with the adjacent position within the intelligent rack 10, and the second end of the slot 42 more spaced from the adjacent position of the intelligent rack 10. This force exerted by the spring 50 is preferably less than a gravity force acting on the specimen tube T, so that the spring 50 is not able to itself move the specimen tube T out of the position within the intelligent rack 10.

While a spring 50 of helical spring steel is effective for the moving element, the spring 50 is preferably stainless steel to avoid interaction with the magnet 60 at the lower end 54. The spring 50 could alternatively be formed of a variety of different materials. As one example, the spring 50 could be formed of a helically wound piece of appropriate plastic material or other non-metal material which has sufficient elasticity and resiliency properties to function as a spring. Alternatively, rather than having a helical form, the moving element 50 could be merely a resilient elongate mass which is straight when unloaded but which can readily bend when small loads are applied thereto, such as the loads which are applied to the moving element when a specimen tube T is placed into one of the positions in the intelligent rack 10. For instance, a rubber material of sufficient hardness and having a solid homogeneous construction could function as an effective alternative.

As another alternative, the moving element 50 could be a rigid or substantially rigid elongate structure. A spring or other resilient force applying device could be provided adjacent to such a rigid elongate moving element to bias the rigid elongate moving element towards a first location closer to the center of the position of the intelligent rack until the specimen tube T is placed within that position and causes such a rigid elongate moving element to be displaced laterally to the second end within the slot 42 spaced from the first end.

A magnet 60 is provided as a portion of a preferred form of sensor on the spring 50 or other moving element, and preferably adjacent the lower end 54 or other tip of the spring 50 or other moving element. This magnet 60 thus moves when the lower end 54 of the spring 50 or other moving element moves. A printed circuit board 70 is preferably provided beneath the bottom plate 40. Detectors 74 are preferably located adjacent each slot 42 and positioned so that the detectors detect a greater or lesser magnetic field associated with the magnet 60 depending on the particular position of the magnet 60, correlating with the particular position of the lower end 54 of the spring 50 or other moving element.

Other forms of detectors 42 could include optical sensors, static charge measuring sensors, acoustical sensors or other position sensing technologies either in existence now or developed in the future. Such other detectors could sense the position of the moving element or sense the tube T presence directly.

The detector 74 is preferably mounted on an underside of the printed circuit board 70 so that dust or any contaminants (i.e. specimens or reactants) falling down onto the printed circuit board 70 are isolated from the detector 74 itself and circuitry printed upon the underside of the printed circuit board 70 and linking the detectors 74 together. This printed circuit board 70 includes a plurality of detectors 74 with one detector 74 preferably associated with each position on the intelligent rack 10. As an alternative, conceivably a smaller number of detectors 74 could be provided which would each measure relative strengths of magnetic fields and sense the positions of magnets 60 at the ends of springs 50 or other moving elements of various different positions within the intelligent rack 10 to calculate which position within the intelligent rack 10 is receiving a specimen tube T therein.

As depicted in FIG. 4, the detectors 74 can be in the form of Hall Effect sensors surface mounted on the undersurface of the printed circuit board 70 and positioned slightly spaced from a center of the positions of the intelligent rack 10, and beneath the second end of the slots 42 spaced laterally from the adjacent position within the intelligent rack 10. In this way, when the magnet 60 moves along with the lower end 54 of the spring 50 or other moving element, responsive to motion of the specimen tube T down into the position within the intelligent rack 10 (along arrow A of FIG. 4) and the spring 50 or other moving element deflects laterally (along arrow B of FIG. 4) the magnet 60 moves closer to the detector 74. Circuitry monitors an intensity of the magnetic field adjacent the detector 74 and is appropriately calibrated to generate a signal indicative that the specimen tube T has been placed within the position adjacent the detector 74 when such an increase in the magnetic field is sensed.

As shown in FIG. 4, one position is empty and the magnet associated with that empty position is spaced a greater distance from the detector 74 in the printed circuit board 70 than is a separate magnet 60 relative to its detector 74 for a position which has a specimen tube T located therein (the right most position shown in FIG. 4). The printed circuit board 70 is coupled to a cable 72 (FIG. 2) which is routed to a computer and which communicates to the computer which particular position within the intelligent rack 10 has had a specimen tube T placed therein.

When the specimen tube T is removed, the spring 50 or other moving element returns to an original position and the detector 74 detects such movement as a decrease in the intensity of the magnetic field adjacent this position. Such a signal, appropriately calibrated, communicates that the specimen tube T has been removed. Position information within a database residing on the computer or associated storage device would then have position information for the specimen tube T removed from the data set so that processes could not be inadvertently conducted on incorrect specimens. Rather, to get position information back into the data set, a user would need to rescan the bar code on the specimen tube T by the bar code scanner 6 (FIG. 5) and then place the specimen tube T back into any space within the intelligent rack 10, which new position in the intelligent rack 10 would then be correlated with the particular specimen within the specimen tube T. In this way, the particular position where the specimen tubes T are placed never matters and the operator need not worry about replacing a specimen tube T in the correct position. The overall system always keeps track of the appropriate position through utilization of the intelligent rack 10.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A sample container holding rack for use with an automatic sample processing apparatus, comprising in combination:
at least one sample container support;
said sample container support having a plurality of positions thereon;
said positions each adapted to hold a sample container;
said positions spaced from each other laterally in at least one dimension;
a sample container presence sensor associated with at least one of said plurality of positions; and
said presence sensor adapted to sense the presence of a sample container at said associated position when a sample container is located at said associated position.

2. The rack of claim 1 wherein each of said plurality of positions has at least one presence sensor associated therewith.

3. The rack of claim 2 wherein said presence sensor includes a moving element, said moving element adapted to move when a sample container is placed within said associated position, and said presence sensor including a detector, said detector adapted to detect a location of said moving element.

4. The rack of claim 3 wherein said moving element includes a magnet thereon, said detector including a magnetic field sensor, said detector located sufficiently close to said magnet on said moving element to have a magnetic field intensity change when said magnet associated with said moving element moves relative to said detector.

5. The rack of claim 4 wherein said moving element is elongate in form with a pivot opposite a tip, said magnet located closer to said tip than to said pivot, said magnetic field sensor associated with said detector including a Hall Effect device, said Hall Effect device located below said tip of said moving element and in a position which is a different distance away from said tip of said moving element before said moving element moves than after said moving element moves, responsive to sample container placement within said associated position.

6. The rack of claim 1 wherein said presence sensor includes at least one motion detection unit positioned to detect motion of the sample container into or out of the position.

7. The rack of claim 1 wherein said presence sensor is adapted to sense presence of sample containers and absence of sample containers at a plurality of positions adjacent said presence sensor.

8. The rack of claim 3 wherein said sample container support includes at least two plates of substantially planar form spaced from each other and oriented substantially parallel with each other, each of said plates having a plurality of holes therein aligned substantially vertically with associated holes of the other one of said at least two plates, said plurality of positions defined at least partially by pairs of said holes in said at least two plates aligned with each other, said moving element adapted to move relative to said associated position and at a location below each of said plates, and with said detector located below said moving element.

9. The rack of claim 8 wherein said moving element includes an elongate spring having a pivot end and a tip opposite said pivot end, said pivot end coupled to a lower one of said at least two plates, said spring biased towards a location at least partially passing into said associated position, such that placement of one of said sample containers into said associated position causes movement of said spring, said detector adapted to detect movement of said tip of said spring away from an original position of said spring.

10. The rack of claim 9 wherein said spring includes a magnet located closer to said tip than to said pivot, said detector including a magnetic field sensor located to have a distance away from said tip which vary before and after movement of said spring.

11. The rack of claim 1 wherein said sample container support includes at least two substantially planar plates spaced in parallel planes vertically spaced from each other and above a bottom plate, said at least two plates including a plurality of holes therein with said holes in said at least two plates aligned together such that pairs of holes in said at least two plates define said positions of said sample container support, said moving element adapted to be positioned at least partially between a lower one of said at least two plates and said bottom plate.

12. The rack of claim 11 wherein said bottom plate includes a plurality of slots therein, said moving elements adapted to move within said slots, said bottom plate including one said slot associated with each of said positions of said sample container support, said slots each adapted to have said moving element located therein, and with said presence sensor including a detector adapted to detect changes in position of said moving element.

13. The rack of claim 12 wherein said holes in said at least two plates are configured within a two-dimensional array, with each of said holes oriented to receive sample container in the form of sample tubes substantially vertically therein, said moving elements each having an elongate form extending between a pivot and a tip, said pivot coupled to a lowermost one of said at least two plates, and with said tip below said lowermost one of said at least two plates and extending at least partially into a position below said holes in said at least two plates defining said associated position, such that said moving element is caused to move when a sample tube is placed within said associated position.

14. The rack of claim 13 wherein said moving element includes an elongate spring having a pivot end and a tip opposite said pivot end, said pivot end coupled to a lower one of said at least two plates, said spring biased towards a location at least partially passing into said associated position, such that placement of one of said specimen tubes into said associated position causes movement of said spring, said detector adapted to detect movement of said tip of said spring away from an original position of said spring.

15. The rack of claim 1 wherein said presence sensor is coupled to a signal generator, said signal generator adapted to generate a signal when presence of a sample container is sensed for said associated position, said signal generator adapted to transmit a signal corresponding with the presence of a sample container within said associated position to a computer, said computer also associated with a sample container information data set, such that said computer can associate sample container position along with other information associated with said sample container in an automated fashion.

16. An automatic fluid processing apparatus, comprising in combination:
a plurality of fluid containers;
a fluid container robotic interface adapted to interact with contents of a plurality of fluid containers and implement a process with at least a portion of the contents within said plurality of fluid containers;
a fluid container ID detector adapted to detect information associated with said plurality of fluid containers;
a computer coupled to said fluid container ID detector and said fluid container robotic interface, said computer adapted to correlate fluid container identification information with process steps conducted upon contents of said fluid container;
a rack for supporting said plurality of fluid containers at known locations;
said rack having a plurality of positions thereon;
said positions each adapted to hold a fluid container therein;
said positions spaced from each other laterally in at least one dimension;
a fluid container presence sensor associated with at least one of said plurality of positions;
said presence sensor adapted to sense the presence of a fluid container at said associated position when a fluid container is located at said associated position; and
said rack adapted to communicate with said computer location information associated within said rack with each said fluid container, such that said computer can correlate fluid container location with other fluid container data.

17. The apparatus of claim 16 wherein said presence sensor includes a moving element, said moving element adapted to move when a fluid container is placed within said associated position, and said presence sensor including a detector, said detector adapted to detect movement of said moving element.

18. The apparatus of claim 17 wherein said presence sensor is coupled to a signal generator, said signal generator adapted to generate a signal when presence of a fluid container is sensed for said associated position, said signal generator adapted to transmit a signal corresponding with the presence of a fluid container within said associated position to a computer, said computer also associated with a fluid container information data set, such that said computer associates fluid container position information along with other information associated with said fluid container in an automated fashion.

19. The apparatus of claim 18 wherein said moving element includes a magnet on said moving element, said detector including a magnetic field sensor, said detector located sufficiently close to said magnet on said moving element to have a magnetic field intensity change when said magnet associated with said moving element moves relative to said detector.

20. The apparatus of claim 19 wherein said moving element is elongate in form with a pivot opposite a tip, said magnet located closer to said tip than to said pivot, said magnetic field sensor associated with said detector including a Hall Effect device, said Hall Effect device located below said tip of said moving element and in a position which is a different distance away from said tip of said moving element before said moving element moves, responsive to fluid container placement within said associated position, than after said moving element moves.

21. The apparatus of claim 20 wherein said fluid container support includes at least two plates of substantially planar form spaced from each other and oriented substantially parallel with each other, each of said plates having a plurality of holes therein aligned substantially vertically with associated holes of the other one of said at least two plates, said plurality of positions defined at least partially by pairs of said holes in opposite said at least two plates aligned with each other, said moving element adapted to move relative to said associated position and at a location below each of said plates, and with said detector located below said moving element.

22. The apparatus of claim 21 wherein said moving element includes an elongate spring with said pivot opposite said tip, said pivot coupled to a lower one of said at least two plates, said springs biased towards positions at least partially passing into said associated position, such that placement of one of said fluid containers in the form of a specimen tube into said associated position causes movement of said spring, said detector adapted to detect movement of said tip of said spring away from an original position of said spring.

23. The apparatus of claim 16 wherein said fluid container is taken from the group including analyte containers, test tubes, specimen tubes, specimen containers and reagent containers.

24. A method for automatic sample processing including the steps of:
providing a sample container holding rack including at least one sample container support, the sample container support having a plurality of positions thereon, the positions each adapted to hold a sample container, the positions spaced from each other laterally in at least one dimension, a sample container presence sensor associated with at least one of the plurality of positions, and the presence sensor adapted to sense the presence of a sample container at the associated position when a sample container is located at the associated position;
placing a sample within one of the sample containers;
entering information associated with said sample into a computer;
inserting the sample container into an empty position in the rack;
detecting said inserting step;
correlating said detecting step with a particular position within the rack; and
communicating the sample container position to the computer such that the computer has sample container position correlated with other sample related data.

25. The method of claim 24 wherein said entering information step includes the step of placing a bar code on the sample container, entering data into the computer correlating with the bar code, and scanning the bar code on the sample container with a bar code scanner coupled to the computer.

26. The method of claim 24 including the further step of removing a sample container from the rack and said removing step automatically causing removal of position data from other data on the computer which correlates with other data associated with the sample container.

27. The method of claim 24 wherein said providing step includes the step of configuring the presence sensor to include a moving element, the moving element adapted to move when a sample container is placed within the associated position, and a detector adapted to detect changes in position of the moving element.

28. The method of claim 27 wherein said providing step includes the moving element having a magnet thereon, the detector including a magnetic field sensor, the detector located sufficiently close to the magnet on the moving element to have a magnetic field intensity change when the magnet associated with the moving element moves relative to the detector; and
wherein the moving element is elongate in form with a pivot opposite a tip, the magnet located closer to the tip than to the pivot, the magnetic field sensor associated with the detector including a Hall Effect device, the Hall Effect device located below the tip of the moving element and in a position which is a different distance away from the tip of the moving element before the moving element moves than after the moving element moves, responsive to sample container placement within the associated position.
